(19) United States
(12) Patent Application Publication
(10) Pub. No.: US 2020/0093667 A1
(43) Pub. Date: Mar. 26, 2020

(54) Novel appendage rest

(71) Applicant: Angela Milton, Gary, IN (US)

(72) Inventor: Angela Milton, Gary, IN (US)

(21) Appl. No.: 16/697,779

(22) Filed: Nov. 27, 2019

Related U.S. Application Data
(60) Provisional application No. 62/772,219, filed on Nov. 28, 2018.

(51) Int. Cl. A61G 5/12; A61G 5/04

(52) U.S. Cl. CPC A61G 5/12; A61G 2220/18; A61G 5/04

(57) ABSTRACT

A brace that is easily attachable and detachable to a seat of a scooter. When used by an amputee the brace provides a surface to comfortably place an amputated appendage. The brace is manufactured to fit around a steering column of a scooter thereby providing ample surface. The user of the present invention can use an included cover to provide various benefits to the appendage.

### CROSS-REFERENCE TO RELATED APPLICATIONS

The present application claims the benefit of U.S. Provisional Patent Application No. 62/772,219, filed Nov. 28, 2018, the entirety of which is hereby incorporated by reference.

### BACKGROUND

Humans receive amputations of their legs and arms regularly in the United States. Such operations occur for various reasons, not only from planned surgeries. Regardless of the reason, the amputee often will end up with only a portion of their pre-existing leg or arm remaining. That portion fails to function fully and requires special care and handling. Too, the remaining appendage may have open wounds.

There many reasons for an amputee to use a scooter for travel rather than a prosthetic device. Such scooters have become common to see in many areas. Scooters are readily available in grocery stores, retail shops, and hospitals. Personal scooters are purchased for use in an amputee's own home or at their place of work.

Scooters characteristically have a space between where the driver sits and the steering column. It allows for placing the legs of a person that has legs while they drive. Such scooter type vehicles have mechanical parts, e.g. a steering column, that make it difficult to fashion an apparatus for supporting an appendage while using the scooter, if the driver has only a stub appendage. Amputee's might place their bags, or other soft materials in the space to allow them to prop up their appendage. However, this fills the space and does not allow the amputee to then use that space for placing their goods while shopping or other items to be carried, which then end up in their laps.

There is a need in the industry for an apparatus that is easy to use, inexpensive, and assists humans in better supporting their amputated appendages while using a scooter type vehicle. The apparatus should not detract from the normal functionality of a scooter, such as having a place to place items or use the steering column.

### SUMMARY

The present invention is directed to an apparatus that satisfies this need. The apparatus comprises a platform that is removably attachable to a vehicle for transporting a handicapped person, a scooter to name one example.

One embodiment of the invention is used to provide support to the leg of an amputee, the appendage, as the amputee rides the scooter. It is covered and prevents scratching or otherwise irritating any open wounds that exist on the amputee's appendage. The device can provide a comfortable platform that is capable of medicating the appendage if needed.

An embodiment of the appendage rest comprises a scooter having a seat. A brace, that is plank like and has a top side and a bottom side. The brace having a proximal portion that is proximal to the seat and attached, using any myriad of connecting mechanisms, to an underside of the seat such that the top side is contacting the underside of the seat. The brace having a distal portion that is distal from the seat. The distal portion extending away from the seat and toward the front of the scooter. Importantly, today's scooters have a seat and a front portion (where the starter, steering column and handlebars are located) separated by a space intended for a rider's legs. It is this in-between space that is presently difficult for an amputee and the problem to be solved by the present invention.

The embodiment has a saddling portion that is attached to the top side. The saddling portion having a first end that is adjacent to the seat and substantially the same length as the distal portion.

Another embodiment of the rest could include a saddling portion being integrally attached to the top side. The two could be manufactured to appear as a single piece, where the saddling portion is padded to provide comfort to the amputee's appendage. I envision any numbers of ways that these two can be attached.

Too, in another embodiment, the appendage rest includes a seat and a saddling portion that are positioned so as to form a substantially horizontal surface for resting an appendage. They are essentially mounted in line with each other forming a bridge that spans the space between the seat and the steering column.

I envision an embodiment of the appendage rest attached to a scooter that has a vertical steering column located at the front of the scooter. The distal portion and saddling portion being configured to accommodate the vertical steering column. So, the shape of the distal portion and the saddling portion are such that they fit around the steering column. The fitting can accommodate, travel around or along, either the left or right side of the column. This allows for a longer surface to place an appendage.

Another embodiment of the appendage rest has a cover with a first edge and a second edge, I envision the cover being rectangular, but any shape will work. The first edge being fixedly attached to the saddling portion, sewn onto the saddling portion to name one example of attaching.

Certainly, the cover can be used to protect the amputee's limb, but it can also include a medium, a salve or medicated solution to name a few examples of mediums.

Another embodiment of the inventive appendage rest illustrates how a scooter has a seat, a brace, the brace being plank like and having a top side and a bottom side. The rest's brace has a proximal portion that is close to, proximal to, the seat. This allows the proximal portion to be attached to the underside of the seat such that the top side is touching the underside of the seat. I envision this attachment ideally being quick and easy for an amputee.

Too, the brace would have a distal portion that is away from, distal from, the seat. The distal portion essentially extends away from the seat and toward the front of the scooter where the handlebars and steering column are located. A saddling portion is integrally attached to the top side. The saddling portion's first end is next to, adjacent to, the seat and is essentially the same length as the distal portion. In this way, the seat and the saddling portion being positioned to form a substantially horizontal surface to rest an appendage, a bridge is formed. The scooter has a vertical steering column located at the front of the scooter which would normally prevent the horizontal surface from extending beyond the column. But in the inventive rest the distal portion is configured, e.g. properly shaped, to accommodate the vertical steering column and extend beyond the vertical column.

This embodiment has a cover with a first edge and a second edge. The first edge being fixedly attached to the saddling portion. Too there is a medium which the cover is impregnated. The cover being capable of covering a limb of a user to provide all sorts of benefits like protection from the elements or warmth to name a few examples. The embodiment is capable of transferring a portion of the medium to the limb. I feel it is inventive that the apparatus should be able to provide some medication to appendages that have open wounds and are placed upon the platform, that is the saddling portion.

Notably, the invention can be easily attached to the chair portion of any scooter. Too it easily fits around the steering column of any scooter and can be adjustable in size to accommodate the user's situation, for example a longer platform for a below knee amputee.

### BRIEF DESCRIPTION OF THE SEVERAL VIEWS OF THE DRAWINGS

These and other features, aspects and advantages of the present invention will become better understood with regard to the following description, appended claims, and accompanying drawings where:

FIG. 1 shows a perspective view of one embodiment of the present invention attached to a scooter.

FIG. 2 shows a plan view of an embodiment of the present invention.

FIG. 3 shows a perspective view of one embodiment of the present invention attached to a scooter being ridden by an amputee.

### DESCRIPTION

### Overview

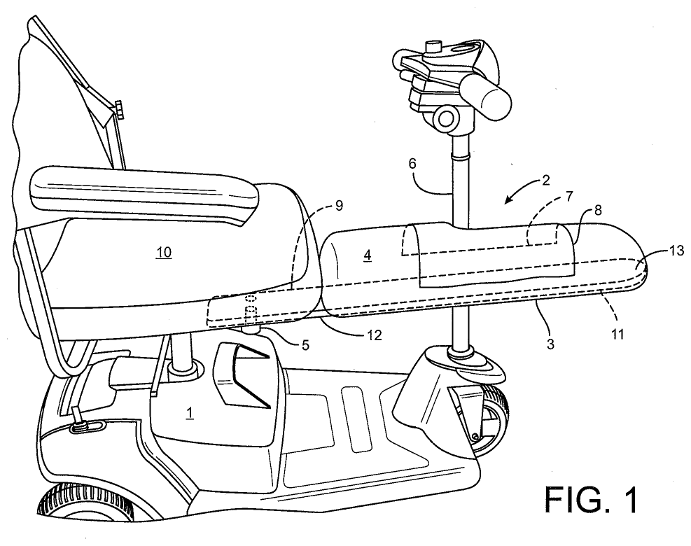

As shown in FIG. 1, one embodiment of the present invention attached to a scooter comprises the scooter 1 with a seat 10. A brace 12 is attached at its proximal portion 9 to the underside of the seat 10 via any myriad of commonly known attaching mechanisms 5. A distal portion 11 of the brace 12 extends away from the seat toward the front of the scooter 1 and past the steering column 6 of the scooter 1.

This embodiment, as can be seen at 2, has been shaped to fit around the steering column 6. A saddling portion 3 is attached to the top side 13 of the brace 12 and generally mimics the size and shape of the distal portion 11. A user's amputated leg (not shown) would rest on the surface 4. A cover 8 is attached to the saddling portion 3 at one edge 7. Notably shown is how the inventive embodiment bridges the gap between the seat 10 and the steering column 6.

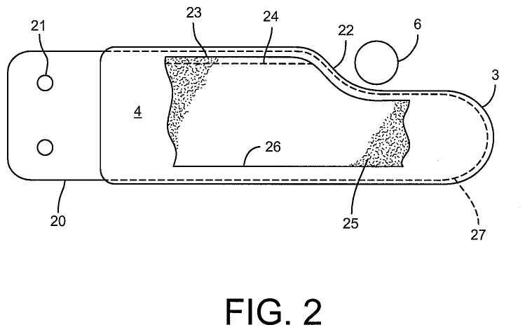

As shown in FIG. 2, a plan view of an embodiment of the present invention comprises a brace 27 having a proximal portion 20 and a distal portion 3. The brace 27 having holes for mounting 21 to a scooter (not shown). A saddling portion 4 is integrally attached to the distal portion 3 and takes the shape generally of that portion. The saddling portion 3 can be made of a padded material, an inflatable plastic, or any other such manufacture that provides a comfortable place to place an appendage. Too, the saddling portion 4 and distal portion 3 may be made such that they are one piece constructed. However, I find the best mode for the attachment of these two elements to be as disclosed.

The distal portion 3 and the saddling portion 4 are shaped at 22 to accommodate a scooter's steering column 6. This shape can also accommodate other parts of a scooter that might get in the way of the intended brace, such as electronics, cabling, brakes, and the like. A cover 26 is attached to the saddling portion 4. In this embodiment, a first edge of the cover 23 is sewn on 24. I envision that this attachment can be done in any number of ways, but the attachment should allow the cover to be pulled away to allow the placing of an appendage, and then placed over that appendage.

The cover 26 in this embodiment is soaked with a medium 25, a medicated salve to name one example of a medium. In this way when the cover 26 comes in contact with an amputee's appendage it can be used to apply the medium 25 to the appendage.

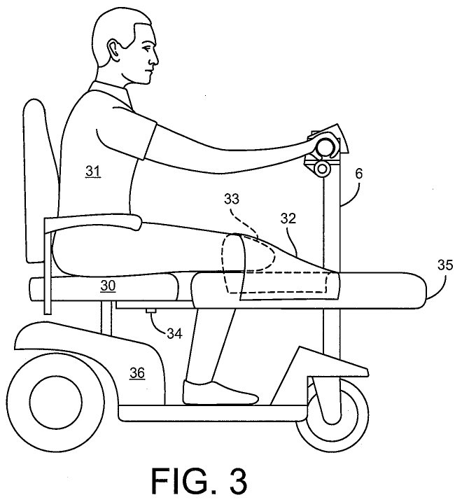

As shown in FIG. 3, a perspective view of one embodiment of the present invention attached to a scooter being ridden by an amputee comprises an amputee 31 who has lost a portion of his leg from surgery or otherwise leaving only a stubbed appendage 33. The amputee 31 is riding a scooter 36 and sits on the seat of the scooter 30.

This embodiment shows the inventive brace 35 attached to the seat 30 via a fastener 34. The brace 35 extends beyond the steering column 6, though a shorter version is possible. A cover 32 which is attached to the brace 35 is covering the appendage 33.

Although the present invention has been described in considerable detail with the reference to certain preferred versions thereof, other versions are possible. For example, the saddling portion and the brace could be manufactured to be all one piece. Too, the saddling portion and distal portion of the brace could be shorter and not need to accommodate the steering column. The spirit of the invention is to provide an amputee, who lost a limb from surgery or otherwise, to more comfortably place their appendage on a rest when driving a scooter. Therefore, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What I claim is:

1. An appendage rest for use on a scooter, the appendage rest comprising:
the scooter having a seat;
a brace;
the brace being plank like;
the brace having a top side and a bottom side;
the brace having a proximal portion that is proximal to the seat
the proximal portion being attached to an underside of the seat such that the top side is contacting the underside of the seat;
the brace having a distal portion that is distal from the seat;
the distal portion extending away from the seat and toward a front of the scooter;
a saddling portion;
the saddling portion being attached to the top side;
the saddling portion having a first end that is adjacent to the seat;
the saddling portion being substantially the same length as the distal portion.

2. The appendage of claim 1 wherein the saddling portion is integrally attached to the top side.

3. The appendage rest of claim 1 wherein the seat and the saddling portion are positioned so as to form a substantially horizontal surface for resting an appendage upon.

4. The appendage rest of claim 3 further comprising:
the scooter having a vertical steering column located at the front of the scooter;
the distal portion being configured to accommodate the vertical steering column.

5. The appendage rest of claim 3 further comprising:
a cover;
the cover having a first edge and a second edge;
the first edge being fixedly attached to the saddling portion.

6. The appendage rest of claim 3 further comprising:
a cover;
the cover having a first edge and a second edge;
the first edge being fixedly attached to the saddling portion;
a medium;
the cover being impregnated with the medium;
the cover being capable of covering a limb of a user.

7. An appendage rest for use on a scooter, the appendage rest comprising:
the scooter having a seat;
a brace;
the brace being plank like;
the brace having a top side and a bottom side;
the brace having a proximal portion that is proximal to the seat
the proximal portion being attached to an underside of the seat such that the top side is touching the underside of the seat;
the brace having a distal portion that is distal from the seat;
the distal portion extending away from the seat and toward a front of the scooter;
a saddling portion;
the saddling portion being integrally attached to the top side;
the saddling portion having a first end that is adjacent to the seat;
the saddling portion being substantially the same length as the distal portion;
the seat and the saddling portion being positioned to form a substantially horizontal surface to rest an appendage;
the scooter having a vertical steering column located at the front of the scooter;
the distal portion being configured to accommodate the vertical steering column and extend beyond the vertical column;
a cover;
the cover having a first edge and a second edge;
the first edge being fixedly attached to the saddling portion;
a medium;
the cover being impregnated with the medium;
the cover being capable of covering a limb of a user.

8. The appendage rest of claim 7 wherein the cover is capable of transferring a portion of the medium to the limb.

9. The appendage of claim 7 wherein the saddling portion is inflatable.
